(19) United States
(12) Patent Application Publication
(10) Pub. No.: US 2002/0078454 A1
(43) Pub. Date: Jun. 20, 2002

(54) System and method for inserting and integrating streaming video content into a digital medium

(76) Inventor: Georges Auberger, Emerald Hills, CA (US)

Correspondence Address: PILLSBURY WINTHROP, LLP, 1600 Tysons Boulevard, McLean, VA, 22102, US

(21) Appl. No.: 09/998,016

(22) Filed: Nov. 29, 2001

Related U.S. Application Data
(60) Provisional application No. 60/250,250, filed on Nov. 29, 2000.

(51) Int. Cl. H04N 7/025; H04N 7/10; G06F 3/00; H04N 5/445; G06F 13/00

(52) U.S. Cl. 725/49; 725/32; 725/48; 725/51

(57) ABSTRACT

The invention disclosed herein relates to a system and method for streaming video content over a communication network. The present invention enables computer users to insert and integrate streaming video content to digital medium such as web pages and the like in an efficient manner without requiring expensive networking tools. This is achieved by providing a system having a video enabling service that receives video content from the user and loads it into web pages and emails. In the manner, whenever a web page or email is presented to the user, video content can be inserted and integrated therein to display both textual and video content to the user.

### CROSS-REFERENCE TO RELATED APPLICATION

This application claims the benefit of prior U.S. Provisional Application Serial No. 60/250,250, filed Nov. 29, 2000, which is hereby incorporated by reference herein.

### FIELD OF THE INVENTION

The present invention relates to a system and method for streaming video content over a communication network. More particularly, the present invention is directed to a system and method for inserting and integrating streaming video content into a digital medium such as a web page or email.

### BACKGROUND OF THE INVENTION

The popularity of the Internet is due, in part, to the ability to stream video content from one computing device to another. As the name indicates, streaming video on the Internet allows users to view pre-recorded or “real-time” video content on their computing devices. Video content can be transmitted to multiple users in real-time as it is being created as in a live broadcast such as a sporting event. Alternatively, pre-recorded video content can be personalized and transmitted using an individual stream to each user. In this manner, the user can stop and start the stream, and may be able to skip forward or backward in the content.

FIG. 1 illustrates a conventional system for streaming video content to a computer user on the Internet. To generate a video stream, the video content is typically stored at a data center or server 2. The server 2 can also access the video content from one or more storage locations or databases 4a . . . 4n and transmit it as video streams to the user computer 6 via the Internet 8. Packets are sent from the server 2 to the user computer 6 via routers, which routers receive the packets on receiving ports and retransmit them using sending ports. Other conventional streaming methods and systems may be apparent to those skilled in the art.

To insert or integrate the streaming video content into an existing web page or email, various burdensome steps are needed. The video content needs to be encoded for playback and stored in the server 2, where it can be streamed to the user computer 6. In addition, the existing web page or email is required to reference the video content for successful insertion and integration. In other words, the Application Service Provider (ASP) or web site operator needs editorial control (e.g., control over destination and updates of content) over the video content to successfully insert and integrate the video content into the existing web page or email. Furthermore, the web site operator is required to possess expensive tools such as encoding tools, steaming servers, and the like to stream video content. As described above, the process of publishing video content into the web page requires many burdensome steps such as recording, encoding, uploading, creating a page for hosting video, etc.

Accordingly, there is a need for a more simplified, efficient, and cost effective system and method for inserting and integrating streaming video content into web pages and emails. There is also a need for a system and method for enabling computer users on the Internet to add streaming video to web pages and emails without having to perform the combined steps described above.

### SUMMARY OF THE INVENTION

In view of the above-described problems of the prior art, it is an object of the present invention to provide a system and method for streaming video content over a communication network for inserting and integrating into a digital medium.

It is another object of the present invention to provide a more efficient and cost-effective system and method for inserting and integrating streaming video content into existing web pages.

It is still another object of the present invention to provide a system and method for streaming video content over a network such as the Internet without requiring expensive network tools.

These and other objects of the present invention are achieved by enabling computer users to insert and integrate streaming video content to web pages and the like in an efficient manner without requiring expensive networking tools. This is achieved by providing a system having a video enabling service that receives video content from the user and loads it into web pages and emails with minimal effort. In the manner, whenever a web page or email is presented to the user, video content can be inserted and integrated therein to display both textual and video content to the user.

### BRIEF DESCRIPTION OF THE DRAWINGS

These and other objects, features and advantages of the present invention are better understood by reading the following detailed description of the preferred embodiments, taken in conjunction with the accompanying drawings, in which:

FIG. 1 illustrates a conventional system for streaming video content to a computer user on the Internet;

FIG. 2 illustrates a system in accordance with the preferred embodiment of the present invention;

FIG. 3 illustrates a more detailed block diagram of a user computer in accordance with the preferred embodiment of the present invention;

FIG. 4 illustrates a flow diagram of the process for inserting and integrating streaming video content into a digital medium in accordance with the preferred embodiment of the present invention;

FIG. 5 illustrates a web page having video content that is presented to the user in accordance with the preferred embodiment of the present invention; and

FIGS. 6A-6B illustrate examples of digital codes used to request the video enabling services in accordance with the preferred embodiment of the present invention.

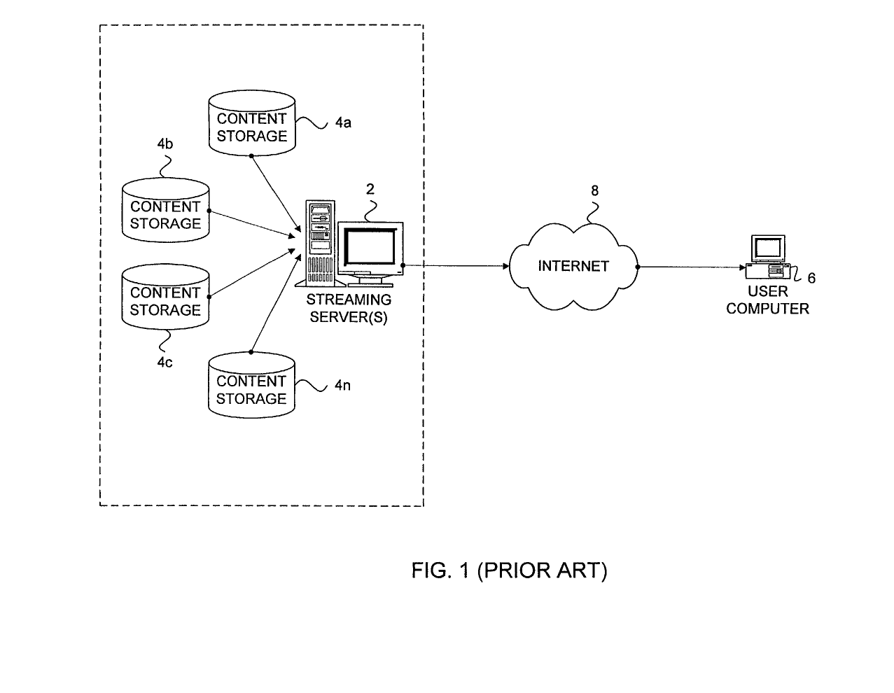

### DETAILED DESCRIPTION OF THE PREFERRED EMBODIMENTS

The present invention will now be described in greater detail, which will serve to further the understanding of the preferred exemplary embodiments of the present invention. As described elsewhere herein, various refinements and substitutions of the various embodiments are possible based on the principles and teachings herein.

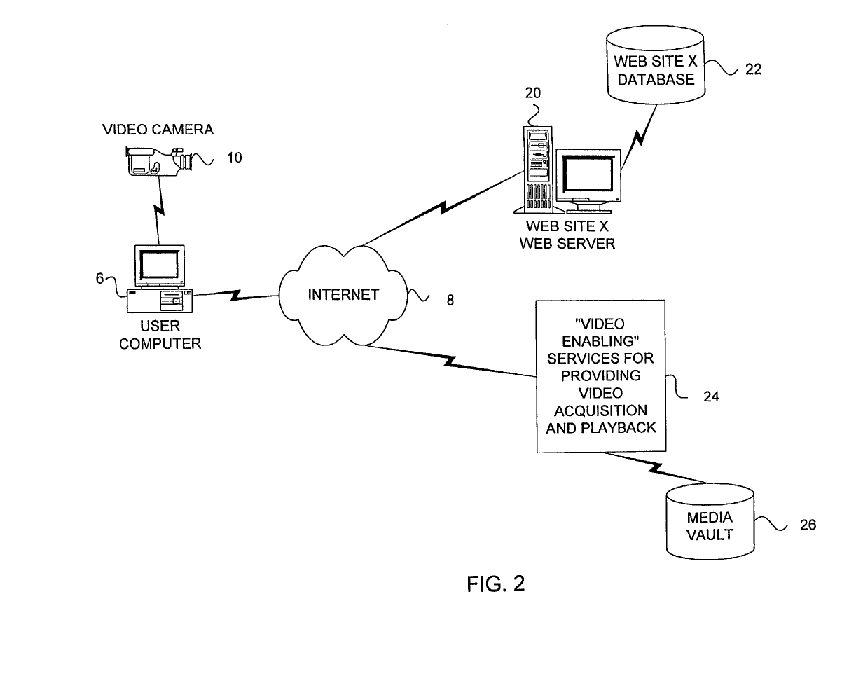

The preferred embodiments of the present invention will now be described with reference to FIGS. 2-6, wherein like components, steps, etc. are designated by like reference numerals throughout the various figures. Further, specific details and parameters are provided herein and are intended to be explanatory rather than limiting.

The present invention is a system and method for streaming video content over a communication network such as the Internet. In particular, the present invention enables computer users to insert and integrate streaming video content to web pages and the like in an efficient manner without requiring expensive networking tools. In the manner, video content can be inserted and integrated into web pages and the like for displaying both textual and video content to the user.

The presently preferred embodiment will now be described with reference to the Internet and a personal computer, although other communication networks such as Intranet, LAN, MAN, WAN, etc., and computing devices such as laptop computers, portable digital assistants (PDA), Net appliances, cellular phones and the like can be used in accordance with the present invention. The computing device described herein can be any device so long as it can transmit and receive data and video content to/from a communication network and display both textual and video content.

FIG. 2 illustrates a system in accordance with the preferred embodiment of the present invention. The present system includes the user computer 6, which is described in greater detail later herein, communicating with a video camera 10 (digital or analog) or any other device that is capable of recording and loading video content onto the user computer 6. The user computer 6 further communicates with a web site X web server 20 (X denoting any web page on the World Wide Web) and a “video enabling” service 24 that provides services for video acquisition and playback on the web site X. A media vault 26 is used for storing the video content for each user. Further, the web server 20 is connected to a database 22 for storing the contents of the web site X. It is noted that multiple user computers can be implemented in the preferred embodiment, but only one user computer 6 is illustrated herein for ease of explanation and understanding.

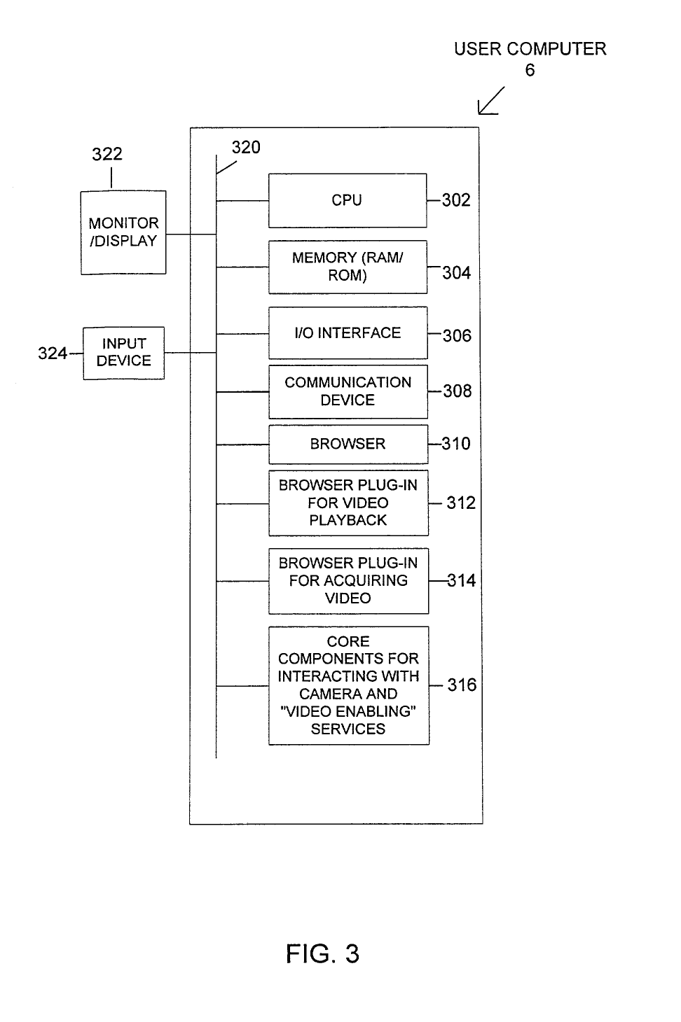

FIG. 3 illustrates a more detailed block diagram of a user computer in accordance with the preferred embodiment of the present invention. The user computer 6, which is used to implement the present invention, typically includes a processor such as CPU 302, internal memory 304 and I/O interface 306, which are coupled to a bus 320. Further coupled to the bus 320 is a communication device 308 for transmitting and receiving data via the Internet 8. The communication device 308 provides the user computer 6 with connections to the Internet and may be any device suitable for such purpose, such as a conventional modem, ISDN adapter, xDSL modem, cable modem, wireless, etc. The user computer 6 also includes I/O devices such a monitor/display 322 and input device 324 such as a keyboard, pointing device, and microphone, which are also coupled to the bus 320.

In addition to the components described above, the user computer 6 includes a browser (web) 310 and browser plug-ins 312, 314 for video playback and acquisition, respectively. The user can access the Internet 8 using one of many commercially available browsers developed by companies such as Netscape (believed to be a Registered Trademark of Netscape Corp.) or Microsoft (believed to be a Registered Trademark of Microsoft Corp.). The user computer 6 also includes core components 316 that are used to interact with the video camera 10 and the “video enabling” services 24. Core components include items such as program software, video camera driver, and the like. The program software is used for downloading video content from the video camera 10, uploading the same to the media vault 26, and other capabilities that are required to implement the present invention.

The functional components described herein are preferably implemented through the program software. Those of ordinary skill in the art will recognize other combinations of hardware and software components are readily applicable in the present invention. As will be apparent to those skilled in the art, the user computer 6 can run any of numerous operating systems, and the program software that is part of the core component 316 can be implemented in any of numerous appropriate computer programming languages or combinations thereof.

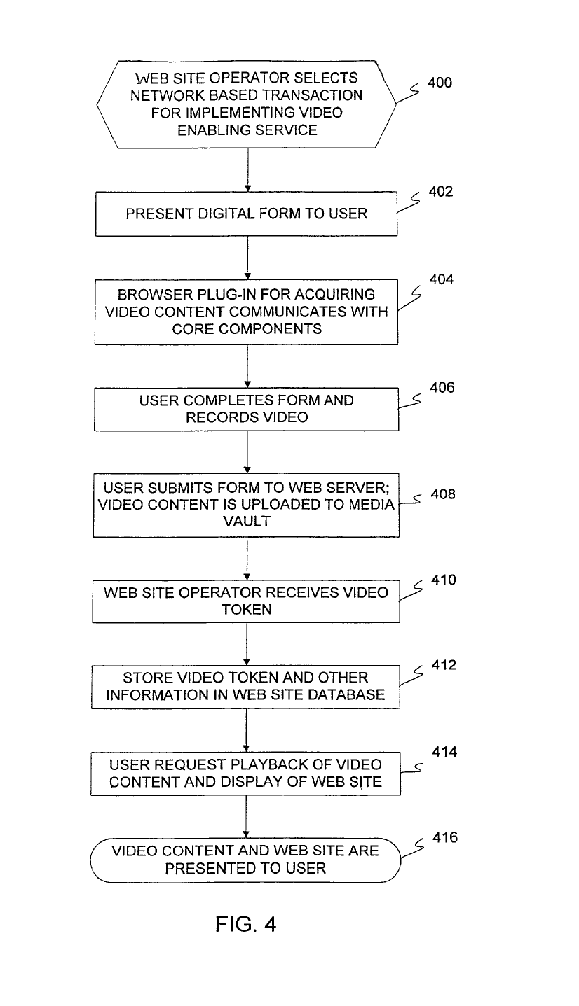

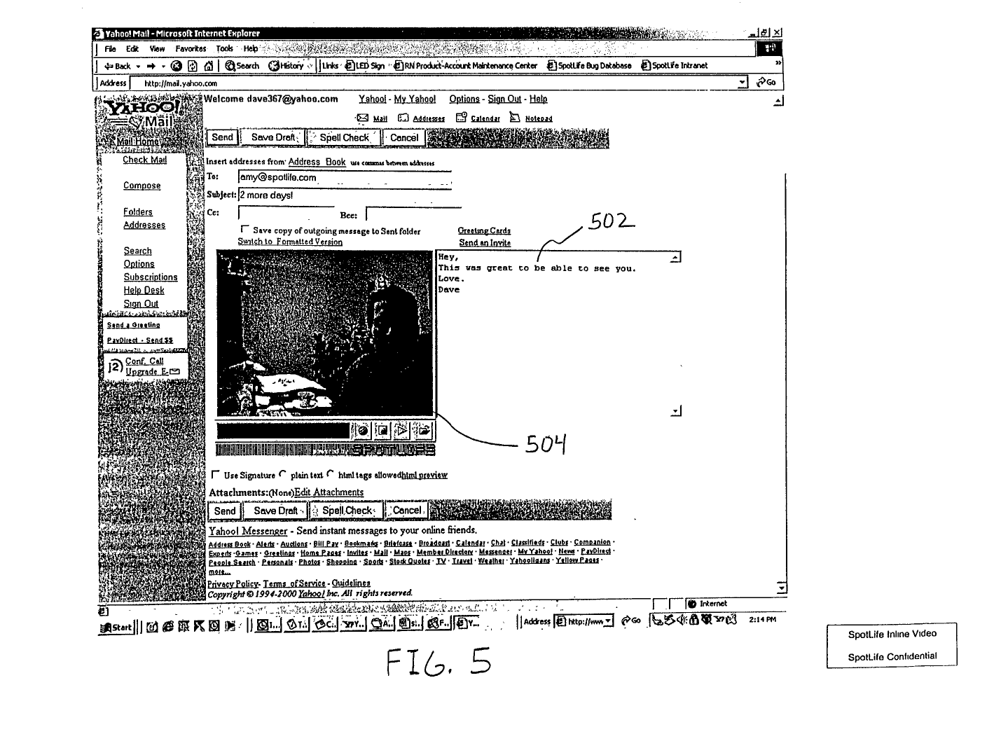

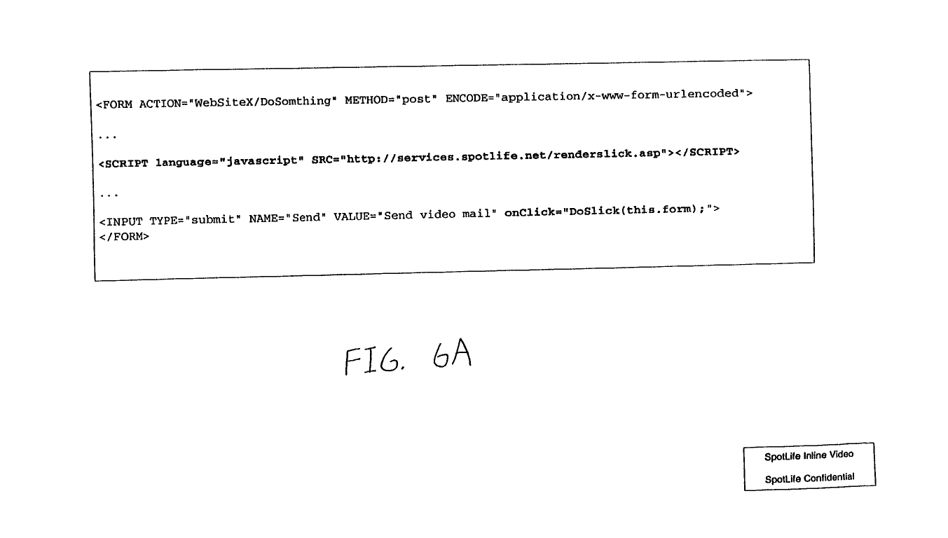

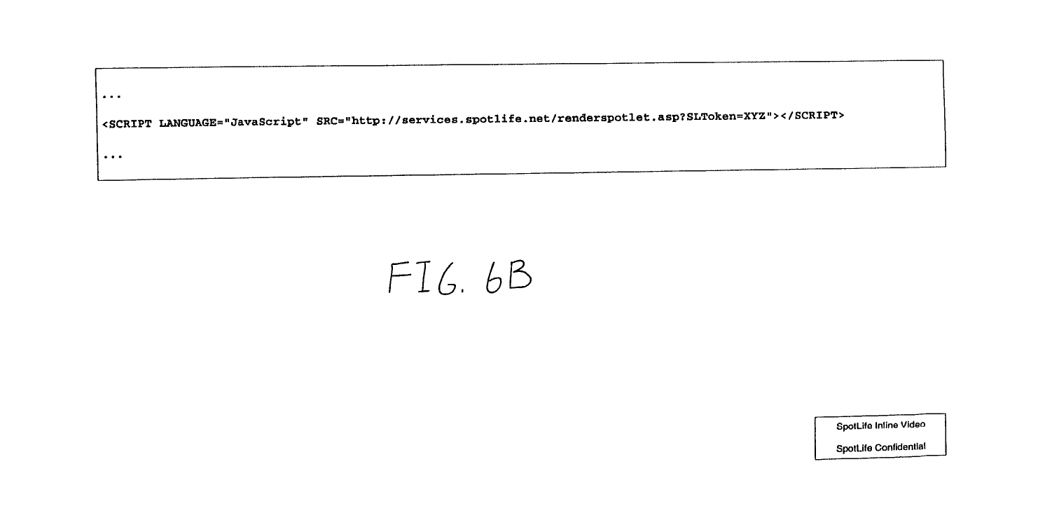

FIG. 4 illustrates a flow diagram of the process for inserting and integrating streaming video content into a digital medium in accordance with the preferred embodiment of the present invention. Reference will be made concurrently to various figures described herein for a more complete understanding of the present invention. In step 400, a web site operator from web site X selects one or more network based transactions for implementing video enabling services. “Transactions” as used herein is a broad term to describe situations where one user submits information on a web site that is shared with other users to that site. Examples include posting of a resume on a job-seeking site, posting an item for sale on a classified site, etc. After the selection process, a digital form is presented to the user on the user computer 6 in step 402. An example of the digital form is illustrated in FIG. 5, which figure also represents the web site/video content presented to the user. The form can be presented to the user in HTML format for a web-based transaction. By adding codes such as the ones illustrated in FIGS. 6A-6B, the form can be used to request the video enabling services 24 to load the browser plug-in 314 for acquiring video content.

When the user is presented with the form, the browser plug-in 314 appears on the form and communicates with the core components 316 on the user computer 6 in step 404. Next, in step 406, the user completes the form using the input device 324 and uses the browser plug-in 314 to record video content using the video camera 10. Alternatively, the user can import an existing video content from the memory 304. When the user submits the completed form in step 408, the video enabling services 24 begin uploading the video content to the media vault 26. Simultaneously, the form is transmitted to the web site x web server 20 and posted on its web site. In step 410, the web site operator receives a video token that uniquely identifies the video content stored on the media vault 26. Since the video token indicates that the video content is associated with a particular web page, the web site operator can use this as a visual indicator that the page is “video enabled.” The video token along with other information on the form are stored in the web site X database 22 in step 412.

Once the video token is stored in the web site X database 22 and the video content is stored in the media vault 26, the user can request playback of the video and display of the web site in step 414. When the request is made, a browser plug-in 312 for video playback is downloaded from the video enabling services 24 onto the user computer 6 in step 414. The web site is loaded onto the user computer 6 along with the accompanying video content from the media vault 26. Again, the video token is used to identify and request the video content from the media vault 26. In this manner, the video content is inserted and integrated into the web site for the user. Finally, the web site and the video content are presented to the user in step 416. FIG. 5 illustrates a web site/page having text 502 and video content 504 that is presented to the user.

Preferably, the user will access a web site or URL (Universal Resource Locator) for implementing “video enabling” services. In other embodiments, the present invention can be implemented in any application or device that renders HTML. For example, video content can be created on a web site and playback can be performed within an email application that is capable of rendering HTML, as illustrated in FIG. 5.

The presently preferred embodiment of the invention is implemented with the above-described processes. However, it is important to note that the present invention is applicable with more or less number of processes than those described hereinabove.

For example, in other embodiments, in-line video capturing is not performed with a browser plug-in, but instead with a stand-alone browser-helper application that is invoked when the user desires to add video content to a page. For example, a form with a link in it that is labeled “Add video” can be used. When the user activates the link, the browser sends a certain data type (mime-type) that is associated with the helper application installed on the user computer. The application can then pop-up and is used to record the video and send it to the video enabling services.

Another embodiment of the present invention allows the web site X to generate the unique video ID itself (this could be useful so it can control authentication of the users). In this case, the video ID would be passed to the video control and then sent to the video enabling service network. The video enabling services would then be required to maintain a mapping table that maps external unique ID from a third party web site to the unique internal reference data.

In the previous descriptions, numerous specific details and examples are set forth such as specific components, devices, software programs, steps, etc., to provide a thorough understanding of the present invention. However, as one having ordinary skill in the art would recognize, the present invention can be practiced without resorting to the details and examples specifically set forth. Those skilled in the art will readily appreciate that many modifications of the exemplary embodiments are possible without materially departing from the novel teachings and advantages of this invention.

I claim:

1. A method of inserting and integrating video data into a streaming digital medium over a communication network, the method comprising:
selecting a transaction for implementing video enabling services;
presenting to a user on a user computing device a digital form;
completing the digital form, wherein the digital form is used to request the video enabling services to load a browser plug-in on the user computing device;
using the browser plug-in to record video data;
uploading the video data to a media vault;
storing a video token into a database; and
loading into the user computing device the digital medium and the video data from the media vault, wherein the video token identifies and requests the video data from the media vault; and
presenting the digital medium and the video data on the user computing device.

2. A method according to claim 1, wherein the digital medium comprises a web page.

3. A method according to claim 1 further comprising presenting the digital form to the user in HTML format.

4. A method according to claim 1 further comprising using the browser plug-in to record video data.

5. A method according to claim 4, wherein the video data is recorded with a video camera.

6. A method according to claim 1, wherein the video token uniquely identifies the video data that is stored in the media vault.

7. A method of inserting and integrating video data into a streaming digital medium, the method comprising:
presenting a browser plug-in and a digital form to the user, wherein the user is prompted to complete the form;
uploading the video data to a media vault upon the user completing the form;
storing a video token in a database, wherein the video token is associated with the video data; and
presenting the digital medium to the user, wherein the video data from the media vault is inserted and integrated into the digital medium.

8. A method according to claim 7, wherein the digital medium comprises an email.

9. A method according to claim 7 further comprising presenting the digital form to the user in HTML format.

10. A method according to claim 7 further comprising using the browser plug-in to record video data.

11. A method according to claim 10, wherein the video data is recorded with a video camera.

12. A method according to claim 7 further comprising importing video data from a memory of a computing device.

13. A method according to claim 1, wherein the video token uniquely identifies the video data that is stored in the media vault.

14. A system for inserting and integrating video data into a streaming digital medium, the system comprising:
means for presenting a browser plug-in and a digital form to the user, wherein the user is prompted to complete the form;
means for uploading the video data to a media vault upon the user completing the form;
means for storing a video token in a database, wherein the video token is associated with the video data; and
means for presenting the digital medium to the user, wherein the video data from the media vault is inserted and integrated into the digital medium.

15. A system according to claim 14, wherein the digital medium comprises one of a web page or an email.

16. A system according to claim 14, wherein the digital form is presented to the user in HTML format.

17. A system according to claim 14, wherein the browser plug-in is used to record video data.

18. A system according to claim 17, wherein the video data is recorded with a video camera.

19. A system according to claim 14, wherein the video data is imported from a memory of a computing device.

20. A system according to claim 14, wherein the video token uniquely identifies the video data that is stored in the media vault.
